(19) United States
(12) Patent Application Publication
(10) Pub. No.: US 2018/0292929 A1
(43) Pub. Date: Oct. 11, 2018

(54) TOUCH DISPLAY AND ELECTRONIC DEVICE

(71) Applicant: Wuhan China Star Optoelectronics Technology Co., Ltd., Wuhan, Hubei (CN)

(72) Inventors: Zhou ZHANG, Shenzhen, Guangdong (CN); Pan XU, Shenzhen, Guangdong (CN); Changwen MA, Shenzhen, Guangdong (CN); Yucheng TSAI, Shenzhen, Guangdong (CN)

(73) Assignee: Wuhan China Star Optoelectronics Technology Co., Ltd., Wuhan, Hubei (CN)

(21) Appl. No.: 15/320,891

(22) PCT Filed: Oct. 25, 2016
(86) PCT No.: PCT/CN2016/103226

§ 371 Date: Dec. 21, 2016

(30) Foreign Application Priority Data
Oct. 8, 2016 (CN) 201610875028.9

(51) Int. Cl. G06F 3/044; G06F 3/041; G02F 1/1333

(52) U.S. Cl. CPC G06F 3/044; G06F 3/0416; G02F 1/133514; G02F 1/13338; G06F 3/0412

(57) ABSTRACT

The present invention provides a touch panel, comprising an array substrate, a touch receiving layer, a touch transmitting layer, a separation layer and a cover plate; the array substrate and the cover plate oppositely located; the touch receiving layer formed at one side of cover plate facing the array substrate, and the separation layer formed at one side of the touch receiving layer away from the cover plate, and the touch transmitting layer formed between the array substrate and the separation layer; a mutual capacitance formed between the touch receiving layer and the touch transmitting layer so that the separation layer can be compressed to change a capacitance value of the mutual capacitance to achieve recognition of a touch position. Embedded 3D touch sensors can be realized and the external pressure touch sensors are not required to be connected to decrease the complexity of the system.

### CROSS REFERENCE

This application claims the priority of Chinese Patent Application No. 201610875028.9, entitled “Touch display and electronic device”, filed on Oct. 8, 2016, the disclosure of which is incorporated herein by reference in its entirety.

### FIELD OF THE INVENTION

The present invention relates to a display technology, and more particularly to a touch display and a mobile terminal.

### BACKGROUND OF THE INVENTION

The touch screen is a sense type liquid crystal display device which can receive input signals of a contact terminal. When the pattern button on the screen receives the input signal, the touch feedback system on the screen can drive audio or video devices according to the pre programmed program, and the mechanical button panel can be replaced. The vivid AV effect can be created with the liquid crystal display images.

The present touch panels can be categorized into 2D touch and 3D touch. The 3D touch is to add the function of one dimension of “heavily pressing” on the basis of 2D touch lightly press, lightly dotting for becoming three dimensions. Namely, the screen has three dimensions of lightly dotting, lightly pressing and heavily pressing.

The touch panel according to prior art generally adds the external pressure touch sensors to realize the 3D touch function. The external pressure touch sensors require being adapted with other parts of the touch panel and increase the complexity of the system.

### SUMMARY OF THE INVENTION

The present invention provides a touch panel and a mobile terminal, in which an embedded 3D touch sensors can be realized and the external pressure touch sensors are not required to be connected to decrease the complexity of the system.

The present invention provides a touch panel, comprising an array substrate, a touch receiving layer, a touch transmitting layer, a separation layer and a cover plate; the array substrate and the cover plate oppositely located; the touch receiving layer formed at one side of cover plate facing the array substrate, and the separation layer formed at one side of the touch receiving layer away from the cover plate, and the touch transmitting layer formed between the array substrate and the separation layer; a mutual capacitance formed between the touch receiving layer and the touch transmitting layer so that the separation layer can be compressed to change a capacitance value of the mutual capacitance to achieve recognition of a touch position.

The separation layer is filled up with optical clear adhesive or optical clear resin.

The touch receiving layer is adhered on a lower surface of the cover plate with glue.

The touch panel further comprises a color film substrate, wherein the color film substrate is adhered to a lower surface of the touch receiving layer with a square seal so that the separation layer is formed in an area surrounded by the square seal.

The touch transmitting layer comprises a plurality of touch transmitting parts located in parallel, and the touch receiving layer comprises a plurality of touch receiving parts located in parallel, and the touch transmitting parts and the touch receiving parts are alternately arranged.

The touch panel further comprises a touch signal line and a control chip, wherein the control chip is formed on the array substrate, and the touch receiving layer is connected with the control chip via the touch signal line.

The touch panel further comprises a drive module, wherein the drive module divides each frame into a display mode and a touch mode to control a signal of the touch transmitting layer, and in the display mode, the drive module provides a display signal to the touch transmitting layer, and in the touch mode, the drive module provides a touch signal to the touch transmitting layer.

The drive module comprises a display signal generation unit, a touch signal generation unit and a switch unit, wherein the switch unit is employed to connect the touch transmitting layer with the display signal generation unit in the display mode, and to connect the touch transmitting layer with the touch signal generation unit in the touch mode.

The touch transmitting layer is manufactured by indium tin oxide.

The present invention further provides a mobile terminal, comprising any touch panel as aforementioned.

In comparison with prior art, the touch receiving layer of the touch panel according to the present invention is formed at one side of the cover plate facing the array substrate, and the separation layer is formed at one side of the touch receiving layer away from the cover plate. The touch receiving layer and the touch transmitting layer between the array substrate and the separation layer form the mutual capacitance. When a finger of an user pressed the cover plate, the separation layer deforms so that the capacitance value of the mutual capacitance of the touch receiving layer and the touch transmitting layer changes. The change of the capacitance value can realize the recognition of the touch position. Because the touch panel according to the present invention can utilize the structure of itself to realize the 3D touch sensor function, i.e. the embedded 3D touch sensor function. No external pressure touch sensors are required. The complexity of the system end can be reduced.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a sectional diagram of a touch panel according to the present invention;

FIG. 2 is a circuit diagram of a drive module in the touch panel according to the present invention;

FIG. 3 is a diagram of a position relationship of a touch receiving layer and a touch transmitting layer in the touch panel of FIG. 1;

FIG. 4 is a diagram of an electric field formed between the touch receiving layer and the touch transmitting layer in the touch panel of FIG. 1.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

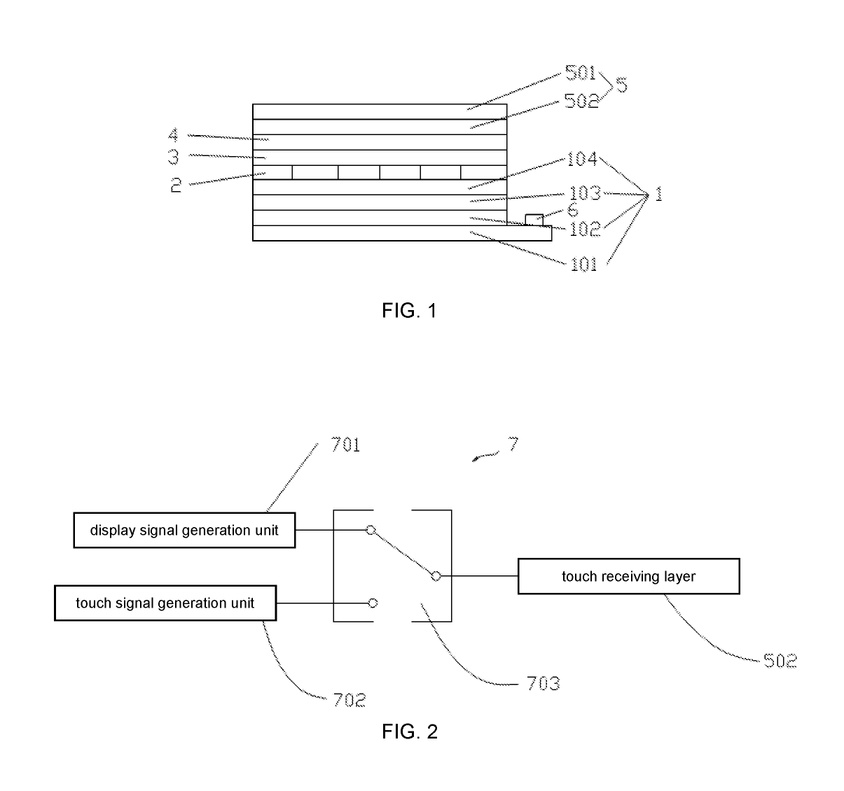

Please refer to FIG. 1. The touch panel according to the present invention comprises an array structure 1, a liquid crystal layer 2, a color film structure 3, a separation layer 4 and a cover plate structure 5, wherein a liquid crystal layer 2 is located between the array structure 1 and the color film structure 3, and the separation layer 4 is located between the color film structure 3 and the cover plate structure 5. Specifically, the array structure 1 comprises an array substrate 101, and a data line layer 102, a gate line layer 103 and a touch receiving layer 104, which are sequentially formed on the array substrate 101, and the color film structure 3 comprises a color film substrate 301 and a RGB filter layer 302, wherein the color film substrate 301 is adhered to a lower surface of the touch receiving layer 502 with a square seal so that the separation layer 4 is formed in an area surrounded by the square seal, and the RGB filter layer 302 is formed at one side of the color film substrate 301 facing the liquid crystal layer 2, and the cover plate structure 5 comprises a cover plate 501 and a touch receiving layer 502, and the touch receiving layer 502 is formed at one side of cover plate 501 facing the liquid crystal layer 2, and specifically, the touch receiving layer 502 is adhered on a lower surface of the cover plate 501 with glue, and the touch receiving layer 104 and the touch receiving layer 502 can act as being two electrodes of a capacitance. When a finger pressed the cover plate 5, the pressing pressure deforms the separation layer 4 between the cover plate structure 5 and the color film structure 3 to influence the couple between the two electrodes near the touch point, and thus to change the capacitance value between the two electrodes. When a value of a mutual capacitance is detected, the touch transmitting layer 104 sequentially sends excitation signals, and the touch receiving layer 502 receives the signal at the same time. Thus, the value of the mutual capacitance between the touch transmitting layer 104 and the touch receiving layer 502, i.e. the value of the mutual capacitance of the two dimension surface for the entire touch screen, can be obtained. According to the touch screen two dimension capacitance change data, the coordinate of each touch point can be calculated, and the 3D touch signal can be provided to the touch panel. Because the touch panel according to the present invention can utilize the structure of itself to realize the 3D touch sensor function, i.e. to realize the embedded 3D touch sensor function without adding external pressure touch sensors. Moreover, there is no special requirement to the system end and the complexity of the system end can be reduced.

Furthermore, the touch panel according to the present invention further comprises a touch signal line (not shown), and the touch signal line connects the touch receiving layer 502 with a control chip 6. The control chip 6 is located on the array substrate 101, and the control chip 6 can receive the signal of the touch receiving layer 502. By analyzing the electric quantity change of the touch receiving layer 502, the capacitance changes of the touch transmitting layer 104 and the touch receiving layer 502 can be analyzed, accordingly. The control chip 6 can use the capacitance signal as the operation signal to be transmitted to the main board, and thus to realize the corresponding operation of the system end.

Preferably, the touch receiving layer 502 is manufactured by ITO (Indium Tin Oxides).

Please refer to FIG. 2, which shows a circuit diagram of a drive module 7 in the touch panel according to the present invention. The drive module 7 divides each frame into a display mode and a touch mode to control a signal of the touch transmitting layer 104, and in the display mode, the drive module 7 provides a display signal to the touch transmitting layer 104, and then, the touch transmitting layer 104 is employed to be a common voltage layer as displaying, and in the touch mode, the drive module 7 provides a touch signal to the touch transmitting layer 104. Specifically, the drive module 7 comprises a display signal generation unit 701, a touch signal generation unit 702 and a switch unit 703. The switch unit 703 is employed to connect the touch transmitting layer 104 with the display signal generation unit 701 in the display mode, and to connect the touch transmitting layer 104 with the touch signal generation unit 702 in the touch mode. Then, a self capacitance will be formed between the touch transmitting layer 104 and the touch receiving layer 502. When a finger pressed the cover plate 5, the pressing pressure deforms the separation layer 4 between the cover plate structure 5 and the color film structure 3 to change the capacitances of the touch transmitting layer 104 and the touch receiving layer 502. With the detection to the aforesaid capacitance change values, the 3D touch signal can be generated, and thus to realize the embedded 3D touch sensor function. Therefore, with the time division control of the switch unit 703 of the drive module 7, the touch panel according to the present invention can realize the result of the integration of display and touch control.

Selectively, the separation layer 4 can be filled with Optical Clear Adhesive (OCA) or Optical Clear Resin (OCR). The Optical Clear Adhesive or Optical Clear Resin has adhesion function so that the touch receiving layer 502 and the cover plate 4 can combine more closely and the Optical Clear Adhesive or Optical Clear Resin is elastic. Thus, when a finger pressed the cover plate, the cover plate 501 still can deform to allow the capacitance between the touch receiving layer 104 and the touch receiving layer 502 change, and thus to realize the 3D touch function.

Specifically, the locations of the data line layer 102 and the gate line layer 103 can be exchanged without influencing the function of the touch panel.

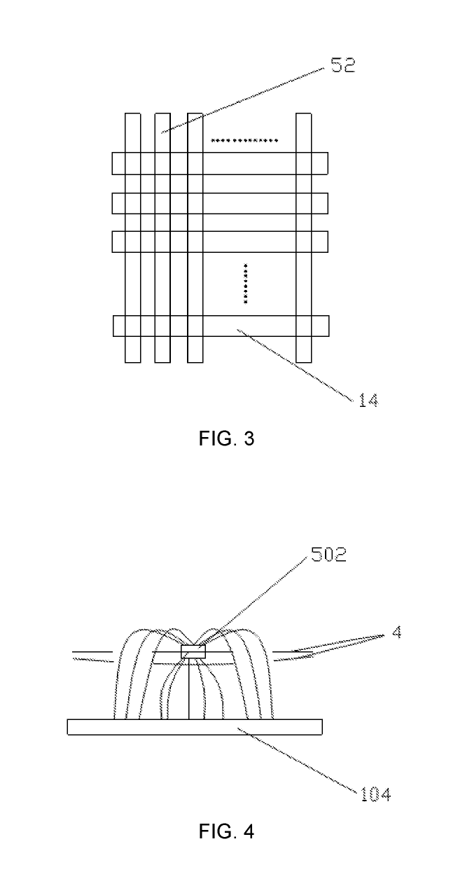

Please refer to FIG. 3, which shows a position relationship of the touch receiving layer 104 and the touch transmitting layer 502. The touch transmitting layer 104 comprises a plurality of touch transmitting parts 14 located in parallel, and the touch receiving layer 502 comprises a plurality of touch receiving parts 52 located in parallel. For instance, the number of the touch transmitting parts 14 is 30 and the number of the touch receiving parts 52 is 18, and the distribution of the touch transmitting parts 14 and the touch receiving parts 52 appear to be perpendicular. Therefore, it can be ensured that the touch control electric field covers every position point of the touch panel. The crossing portion of the touch transmitting part 14 and the touch receiving part 52 can form two electrodes of a mutual capacitance. When a finger pressed the cover plate 5, the pressing pressure deforms the separation layer 4 between the cover plate structure 5 and the color film structure 3 to influence the couple between the two electrodes near the touch point, and thus to change the capacitance value between the two electrodes. When a value of a mutual capacitance is detected, the touch transmitting layer 104 sequentially sends excitation signals, and the touch receiving layer 502 receives the signal at the same time. Thus, the value of the mutual capacitance between the touch transmitting layer 104 and the touch receiving layer 502, i.e. the value of the mutual capacitance of the two dimension surface for the entire touch screen, can be obtained. According to the touch screen two dimension capacitance change data, the coordinate of each touch point can be calculated, and thus, the embedded 3D touch sensor function can be realized.

Specifically, other distributions can exist between the touch transmitting part 14 of the touch transmitting layer 104 and the touch receiving part 52 of the touch receiving layer 502, such as the distribution of appearing 45 degrees angle.

Please refer to FIG. 4, which shows an electric field formed between the touch receiving layer 104 and the touch transmitting layer 502. The electric field lines indicated by the full lines have a portion distributed at one side of the cover plate away from the array substrate 101. The portion of the electric field lines can be employed for 2D touch control, and the electric field lines indicated by the dotted lines are distributed between the touch receiving layer 104 and the touch transmitting layer 502. Thus, when a finger pressed the cover plate, the cover plate 501 still can deform to allow the capacitance between the touch receiving layer 104 and the touch receiving layer 502 change, and thus to realize the 3D touch function. The 2D touch and the 3D touch can be realized by time division. Alternatively, the signals of the 2D touch and the 3D touch can be collected at the same time and transmitted to the control chip 6 for separation treatment. Therefore, the touch panel according to the present invention can realize the functions of 2D touch and 3D touch at the same time.

The touch panel provided by the present invention can be utilized in kinds of mobile terminals. For instance, the mobile terminals can comprise a user equipment communicating with one or more core webs via a wireless access network RAN. The user equipment can be a mobile phone (cellular phone), a computer having a mobile terminal. Moreover, the user equipment can be a mobile device which is portable, in pocket, handheld, or set in the computer or a car. They switch the audio and or data with the wireless access network. For example, the mobile terminals can comprise the cell phone, the tablet, the personal digital assistant (PDA), a point of sale (POS) or a vehicle computer.

Above are embodiments of the present invention, which does not limit the scope of the present invention. Any modifications, equivalent replacements or improvements within the spirit and principles of the embodiment described above should be covered by the protected scope of the invention.

What is claimed is:

1. A touch panel, comprising an array substrate, a touch receiving layer, a touch transmitting layer, a separation layer and a cover plate; the array substrate and the cover plate oppositely located; the touch receiving layer formed at one side of cover plate facing the array substrate, and the separation layer formed at one side of the touch receiving layer away from the cover plate, and the touch transmitting layer formed between the array substrate and the separation layer; a mutual capacitance formed between the touch receiving layer and the touch transmitting layer so that the separation layer can be compressed to change a capacitance value of the mutual capacitance to achieve recognition of a touch position.

2. The touch panel according to claim 1, wherein a material of the separation layer is optical clear adhesive or optical clear resin.

3. The touch panel according to claim 2, wherein the touch receiving layer is adhered on the cover plate with glue.

4. The touch panel according to claim 3, further comprising a color film substrate, wherein the color film substrate is adhered to a surface of the touch receiving layer which is opposite to the separation layer with a square seal, and the separation layer is formed in an area surrounded by the square seal.

5. The touch panel according to claim 4, wherein the touch transmitting layer comprises a plurality of touch transmitting parts located in parallel, and the touch receiving layer comprises a plurality of touch receiving parts located in parallel, and the touch transmitting parts and the touch receiving parts are alternately arranged.

6. The touch panel according to claim 5, further comprising a touch signal line and a control chip, wherein the control chip is formed on the array substrate, and the touch receiving layer is connected with the control chip via the touch signal line.

7. The touch panel according to claim 1, further comprising a drive module, wherein the drive module divides each frame into a display mode and a touch mode to control a signal of the touch transmitting layer, and in the display mode, the drive module provides a display signal to the touch transmitting layer, and in the touch mode, the drive module provides a touch signal to the touch transmitting layer.

8. The touch panel according to claim 7, wherein the drive module comprises a display signal generation unit, a touch signal generation unit and a switch unit, wherein the switch unit is employed to connect the touch transmitting layer with the display signal generation unit in the display mode, and to connect the touch transmitting layer with the touch signal generation unit in the touch mode.

9. The touch panel according to claim 8, wherein the touch transmitting layer is manufactured by indium tin oxide.

10. A mobile terminal, comprising the touch panel according to claim 1.
